(19) United States
(12) Patent Application Publication
(10) Pub. No.: US 2016/0039075 A1
(43) Pub. Date: Feb. 11, 2016

(54) Ratcheting Wrench

(71) Applicant: New Way Tools Co., Ltd., Taichung City (TW)

(72) Inventor: Ping-Wen Huang, Taichung City (TW)

(21) Appl. No.: 14/484,321

(22) Filed: Sep. 12, 2014

(30) Foreign Application Priority Data
Aug. 7, 2014 (TW) 103127065

(51) Int. Cl. B25B 13/46; B25B 23/00

(52) U.S. Cl. CPC B25B 13/46; B25B 23/0007

(57) ABSTRACT

A ratcheting wrench includes a body configured to include a first jaw, a second jaw and a gap in between. The second jaw has an edge thereof including a first restraining structure. A ratchet mechanism connects to the second jaw and includes a slider, a pawl, and a biasing member. The slider is movable and disposed on the second jaw. The slider bears the pawl. The pawl includes a second restraining structure. The biasing member connects to the slider.

### BACKGROUND OF THE INVENTION

1. Field of the Invention

The present invention relates to a wrench and, in particular, to a ratcheting wrench. The ratcheting wrench includes parts able to be assembled easily. Furthermore, the ratcheting wrench has an anti-slip effect.

2. Description of the Related Art

TW Pat. No. 1307652 shows a reversely movable and fast operable open end wrench. The open end wrench includes two projections and an open end between the two projections. A jaw block is movably mounted on one of the two projections and cooperates with a jaw formed from the other of the two projections. The jaw block and the jaw delimit an object clamping area therebetween. Additionally, the jaw block is prevented from moving in order to turn an object. However, it is not easy to stop the jaw block from moving inadvertently. Moreover, if the jaw block moves inadvertently, the open end wrench will not be able to withstand a large torque transmission.

The present invention is, therefore, intended to provide a wrench that is easier to assemble and is made at a reduced cost than the prior art.

### SUMMARY OF THE INVENTION

According to the present invention, a ratcheting wrench having an anti-slip effect includes a body. The body includes a first body portion and a second body portion. The second body portion extends from the first body portion. The second body portion is configured to include a first jaw and a second jaw. The first and second jaws include a gap in between. The second jaw has an edge thereof including a first restraining structure. A ratchet mechanism connects to the second jaw and includes a slider, a pawl, and a biasing member. The slider is movable and disposed on the second jaw. The slider bears the pawl. The pawl includes a second restraining structure. The biasing member connects to the slider. the pawl is selectively changeable between a first position in which the second restraining structure corresponds to and engages with the first restraining structure and a second position in which the second restraining structure disengages from the first restraining structure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an objective of the present invention to provide a ratcheting wrench.

It is another objective of the present invention to provide a ratcheting wrench including parts able to be assembled easily.

It is yet another objective of the present invention to provide a ratcheting wrench having an anti-slip effect.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a partial, perspective view of a ratcheting wrench in accordance with a first embodiment of the present invention.

FIG. 2 is an exploded perspective view of the ratcheting wrench of the first embodiment of the present invention.

FIG. 3 is a cross-sectional view taken along line 3-3 of FIG. 1.

FIG. 4 shows the ratcheting wrench of the first embodiment of the present invention in operation to turn an object.

FIG. 5 is a cross-sectional view relating to FIG. 4 and showing the ratcheting wrench in operation to rotate relative to the object and in which the ratcheting wrench is to be turned in a direction opposite to that of FIG. 4.

FIG. 6 is a cross-section view relating to FIG. 5 and showing the ratcheting wrench in further operation to rotate relative to the object.

FIG. 7 is a partial, exploded perspective view of a ratcheting wrench in accordance with a second embodiment of the present invention.

FIG. 8 is a cross-sectional view of the ratcheting wrench of the second embodiment of the present invention.

FIG. 9 is a partial, exploded perspective view of a ratcheting wrench in accordance with a third embodiment of the present invention.

FIG. 10 is a partial, cross-sectional view of the ratcheting wrench of the third embodiment of the present invention.

FIG. 11 shows the ratcheting wrench of the third embodiment of the present invention in operation to rotate relative to an object.

FIG. 12 is a partial, exploded perspective view of a ratcheting wrench in accordance with a fourth embodiment of the present invention.

### DETAILED DESCRIPTION OF THE INVENTION

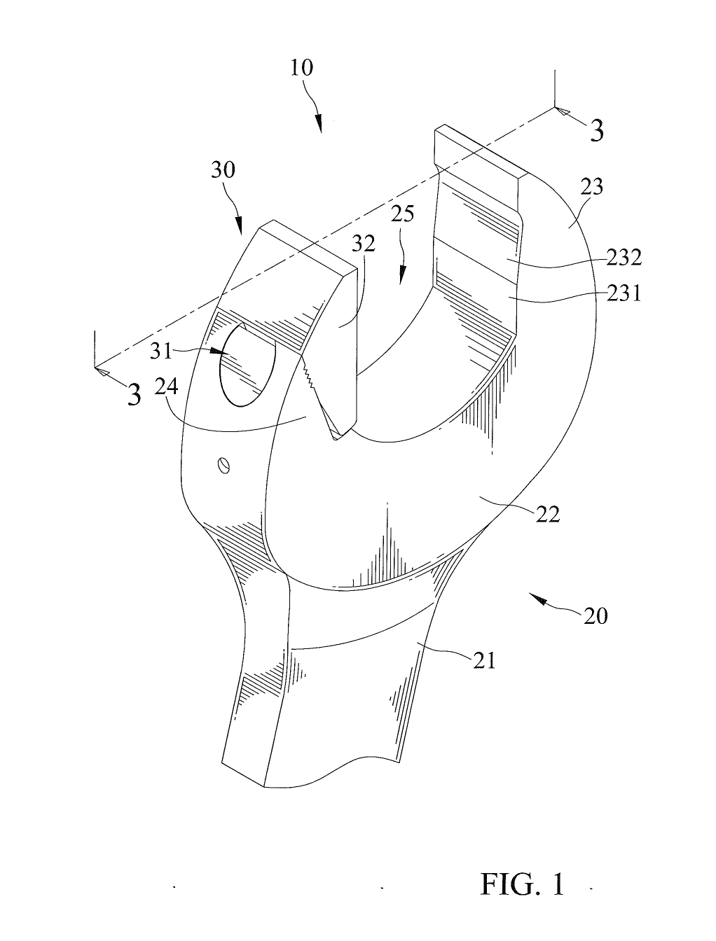

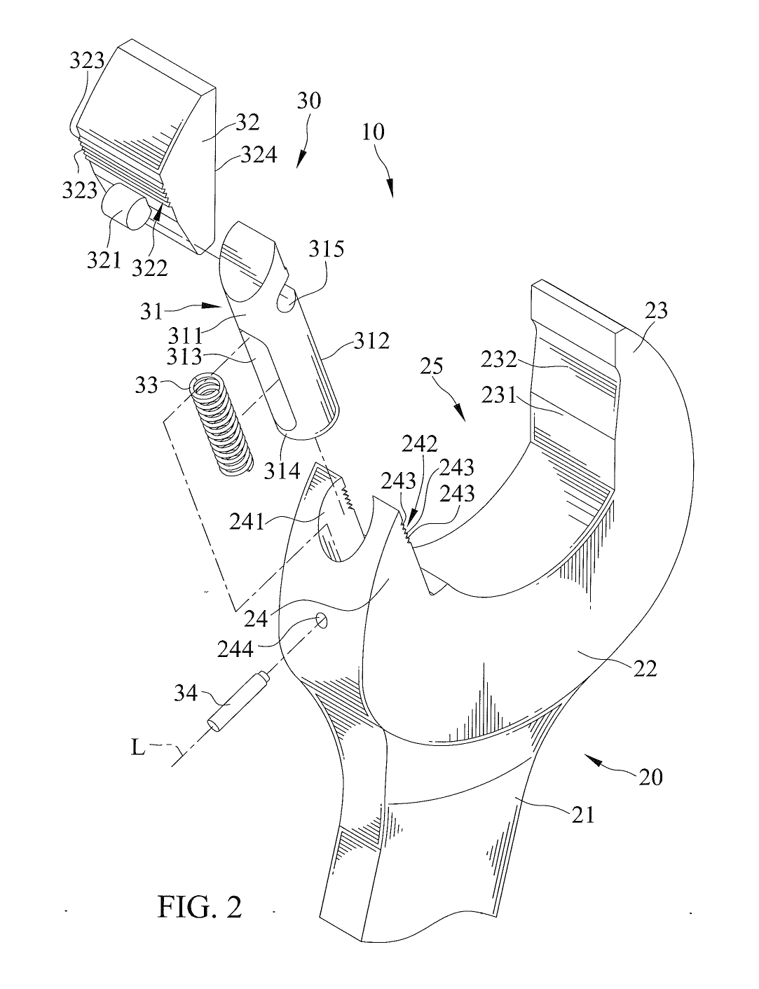

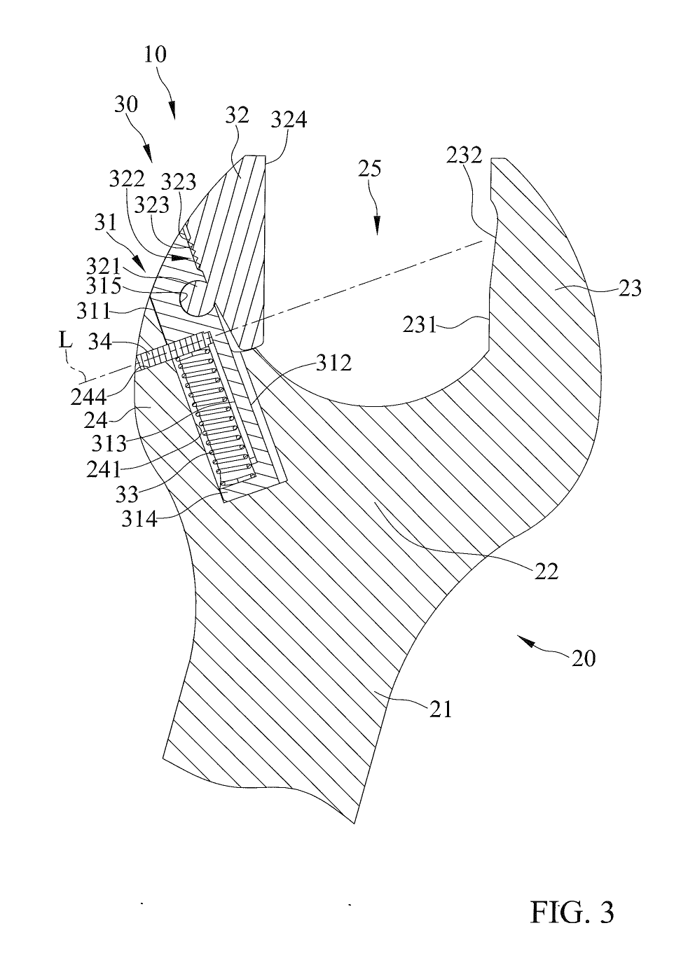

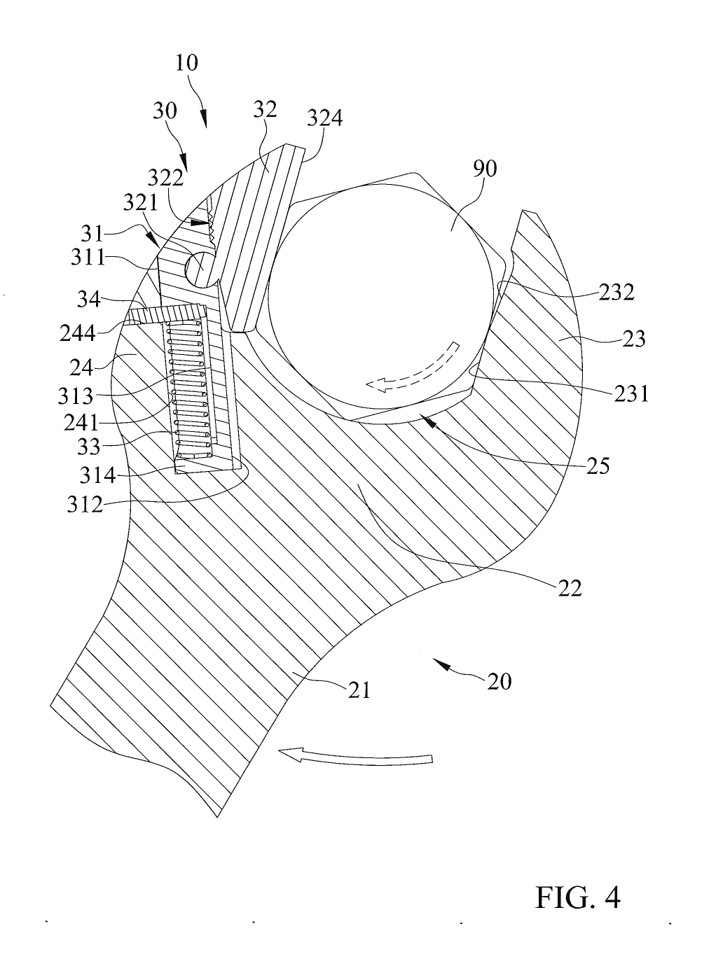

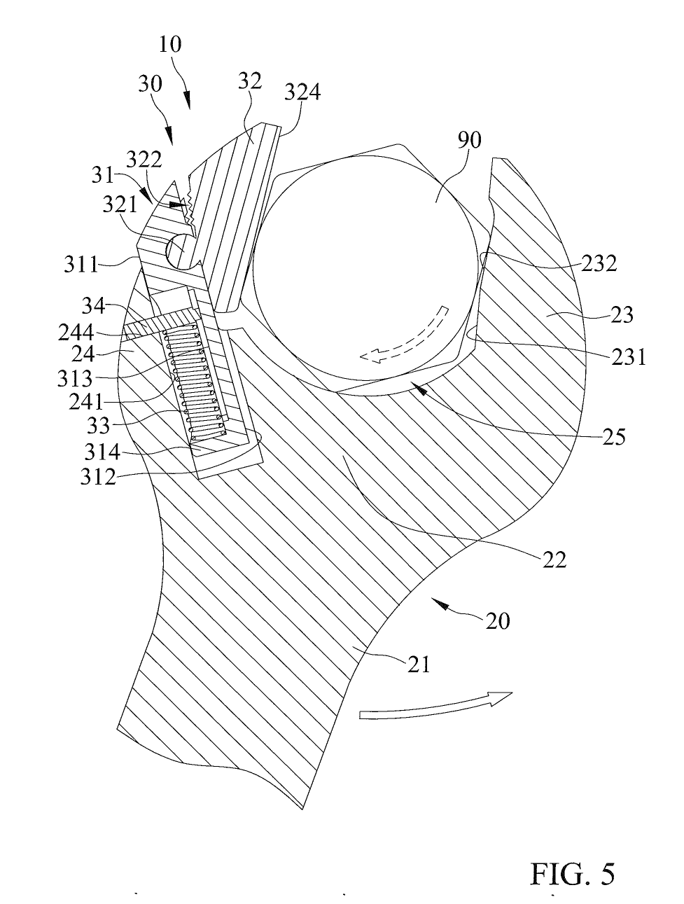

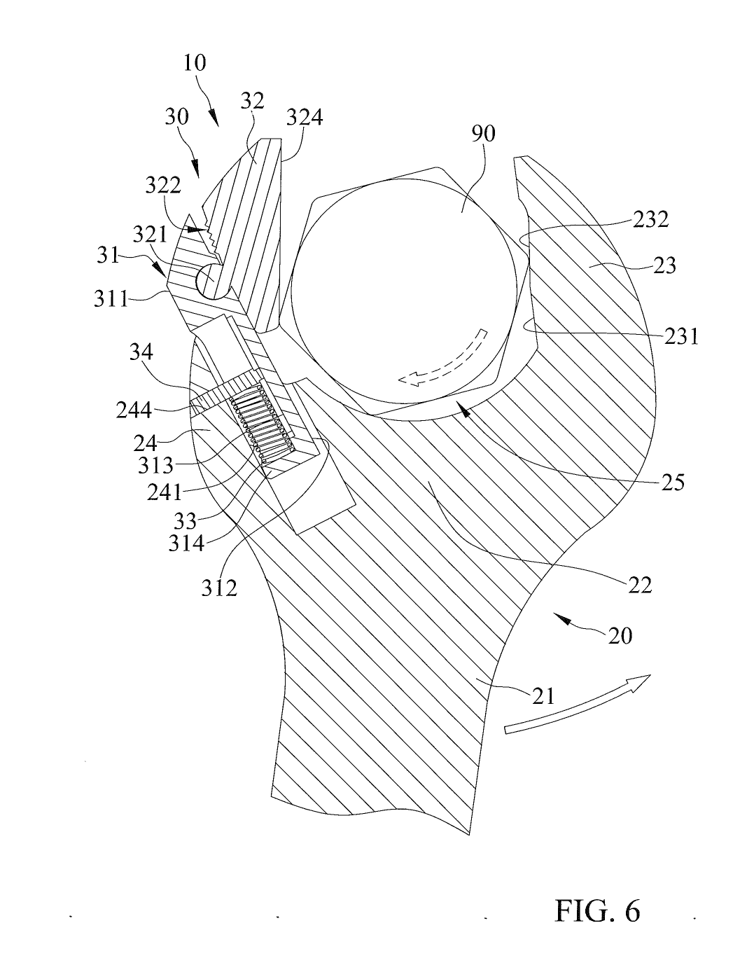

FIGS. 1 through 6 show a ratcheting wrench 10 in accordance with a second embodiment of the present invention. The ratcheting wrench 10 includes a body 20 and a ratchet mechanism 30.

The body 20 includes a first body portion 21 and a second body portion 22. The body 20 is a one piece structure, but not limiting. Therefore, the first and second portions 21 and 22 of the body 20 are an integral and single structure and made of the same material. The second body portion 22 extends from the first body portion 21. The second body portion 22 is configured to include a first jaw 23 and a second jaw 24. The first and second jaws 23 and 24 include a gap 25 in between. The gap 25 is U shaped. The gap 25 defines a clamping area of the ratcheting wrench 10. The first jaw 23 has an inner periphery thereof facing the gap 25 and including a first inner side 231 and a second inner side 232. The first and second inner sides 231 and 232 of the first jaw 23 have a common edge. The first and second inner sides 231 and 232 of the first jaw 23 define two slopes, but not limiting. The second jaw 24 includes the edge thereof including a slot 241. The slot 241 has first and second distal ends opposite one another in a length direction of the slot 241. The length direction of the slot 241 is perpendicular to the width direction of the second jaw 24. The slot 241 includes the first distal end thereof delimited by a wall of the second jaw 24 and the second distal end thereof forming an opening. The second jaw 24 has the edge thereof including a first restraining structure 242. The first restraining structure 242 is serrated. The first restraining structure 242 includes plurality of teeth 243. Each of the plurality of teeth 243 has a length extending in a width direction of the second jaw 24. The second jaw 24 includes the edge adjacent to and facing the gap 25. The second jaw 24 includes a hole 244 extending along a phantom axis L. The hole 244 extends through the second jaw 24.

The ratchet mechanism 30 connects to the second jaw 24 and includes a slider 31, a pawl 32, and a biasing member 33. The slider 31 is movable and disposed on the second jaw 24. The slider 31 is movable and engages in the slot 241. The slider 31 is movable in an axial path in the slot 241. The slider 31 is movable in the length direction of the slot 241. The slider 31 moves relative to the second jaw 24. The slider 31 defines a stop edge 314. The slider 31 is adapted to move towards the first distal end of the slot 241 and will stop when the stop edge 314 abuts against the first distal end of the slot 241. The slider 31 has a distal end opposite the stop edge 314, and the end and the stop edge 314 are opposite in the length direction of the slider 31. The slider 31 is movable between a position in which the distal end thereof is not exposed outside the second distal end of the slot 241 and a position in which the distal end thereof is exposed outside the second distal end of the slot 241. The channel 313 and the hole 24 are connected. The channel 313 has a length in a length direction of the slider 31 and a depth perpendicular to the length direction of the slider 31. The length and width directions of the slider 31 are perpendicular to one another. The channel 313 has a uniform depth. The slider 31 has a first side 311 and a second side 312 opposite the first side 311. The channel 313 is on the first side 311 of the slider 31. A stopper 34 is disposed on the second jaw 24 and retrains the slider 31 on the second jaw 24. The slider 31 includes a side thereof including a channel 313. The stopper 34 is received in the hole 244 and protrudes into the channel 313. The slider 31 bears the pawl 32. The pawl 32 includes a second restraining structure 322. The second restraining structure 322 is serrated. The second restraining structure 322 includes plurality of teeth 323. Each of the plurality of teeth 323 has a length extending in the width direction of the second jaw 24. The first and second restraining structures 242 and 322 have corresponding shapes. The pawl 32 has a facet 324 facing the gap 25 and cooperating with the first jaw 23. The pawl 32 pivotally engages with the slider 31. The slider 31 includes a recess 315 and the pawl 32 includes a projection 321 pivotally engaging in the recess 315. The projection 321 is adjacent to the second restraining structure 322. The recess 315 has an arcuate periphery. Likewise, the projection 321 has an arcuate periphery, which corresponds to the shape of the recess 315. The recess 315 is on the second side 312 of the slider 31. The biasing member 33 connects to the slider 31. The biasing member 33 is disposed in the channel 313. The slider 31 and the biasing member 33 are disposed side by side in a width direction of the slot 241, which is perpendicular to the length direction of the slot 241. The biasing member 33 has a first end restrained by the stopper 34 and a second end restrained by a wall of the channel 313. The biasing member 33 is a spring, but not limiting. The biasing member 33 includes a plurality of loops. The loops of the biasing member 33 are in a coaxial relationship.

A user using the ratcheting wrench can grasp on the first body portion 21a to gain a better leverage. Preferably, the first body portion 21a is elongated. When the ratcheting wrench 10 is used to turn an object 90, the object 90 is limited within the clamping area 25 and is adapted to engage with the first and second inner sides 231 and 232 of the first jaw 23 and the facet 324 of the pawl 32. The pawl 32 is selectively changeable between a first position in which the second restraining structure 322 corresponds to and engages with the first restraining structure 242 and a second position in which the second restraining structure 322 disengages from the first restraining structure 242. The pawl 32 and the second jaw 24 can anti-slip relative to one another when the first and second restraining structures 242 and 322 engage with one another.

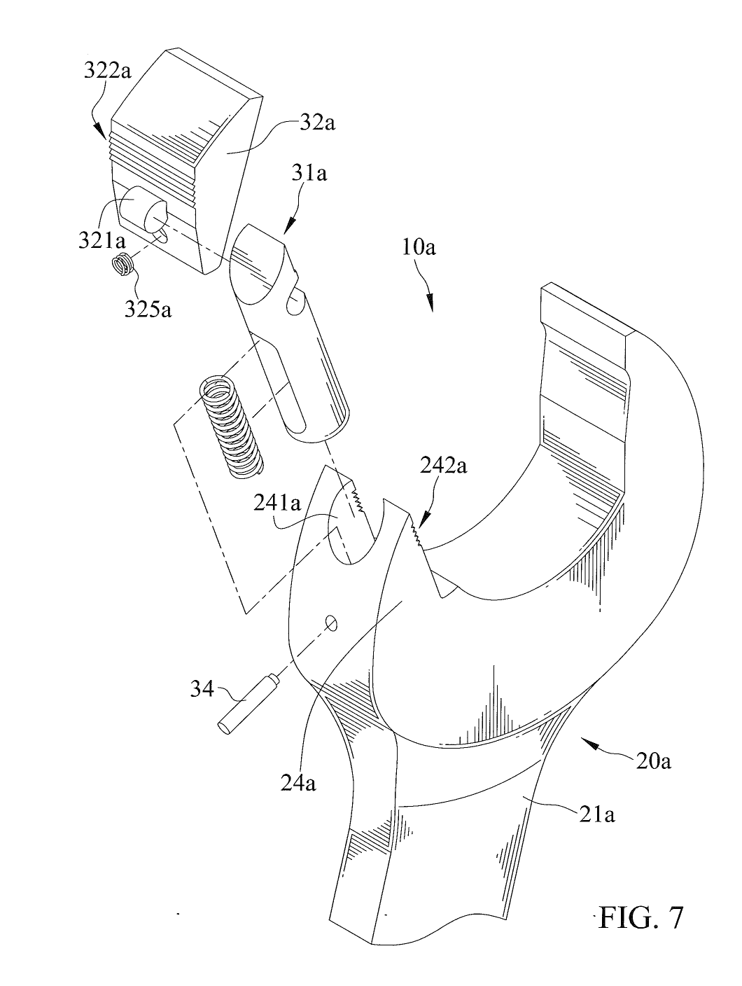

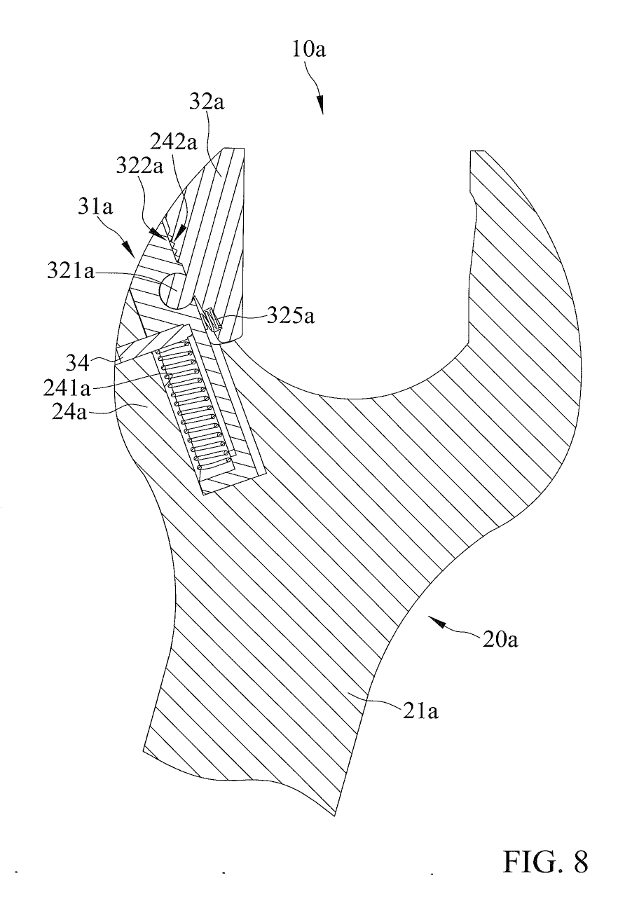

FIGS. 7 and 8 show a ratcheting wrench 10a in accordance with a second embodiment of the present invention. The ratcheting wrench 10a is similar to the ratcheting wrench 10. A body 20a includes a first body portion 21a. A second jaw 24a has an edge thereof including a first restraining structure 242a. A slider 31a is movable and disposed on the second jaw 24a. A pawl 32 includes has an edge thereof including a second restraining structure 322a. The second restraining structure 322a is serrated. The first and second restraining structures 242a and 322a have corresponding shapes. The pawl 32 pivotally engages with the slider 31. The pawl 32 includes a projection 321a. The projection 321a is adjacent to the second restraining structure 322a. The projection 321a has an arcuate periphery. However, the ratcheting wrench 10a differentiates from the ratcheting wrench 10 in that it includes an elastic member 325a connecting the slider 31a and the pawl 32a. The elastic member 325a is adapted to exert a force on the pawl 32a in a direction making the second restraining structure 322a toward a first restraining structure 242a. The elastic member 325a is a spring, but not limiting. The elastic member 325a includes a plurality of loops. The loops of the biasing member 33 are in a coaxial relationship. The pawl 32a has a cavity and an end of the elastic member 325a engages in and abuts against a wall of the cavity and another end abuts against an outer periphery of a slider 31a.

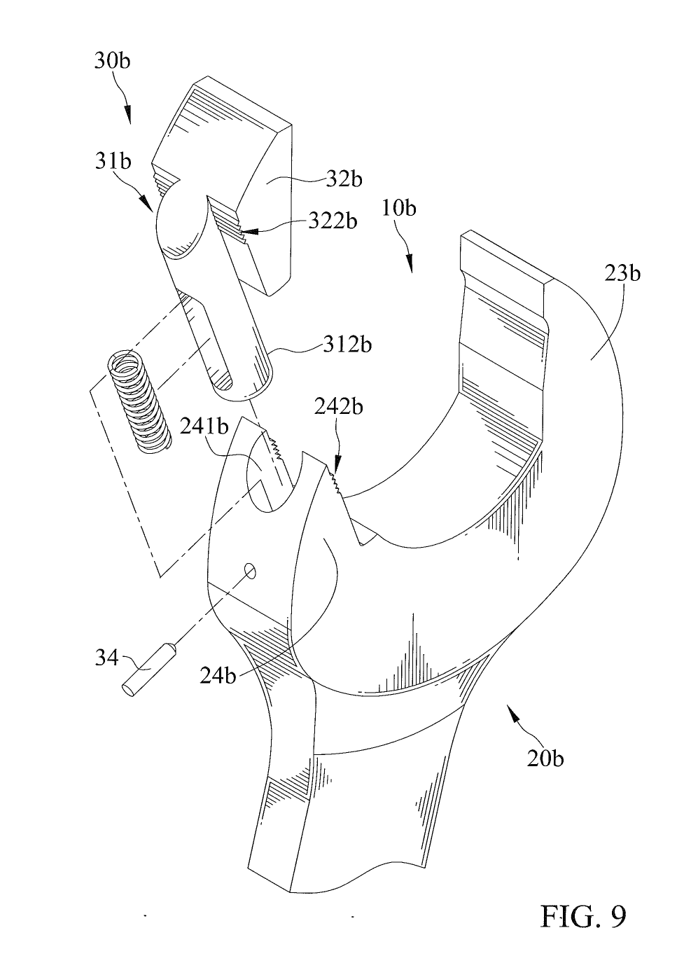

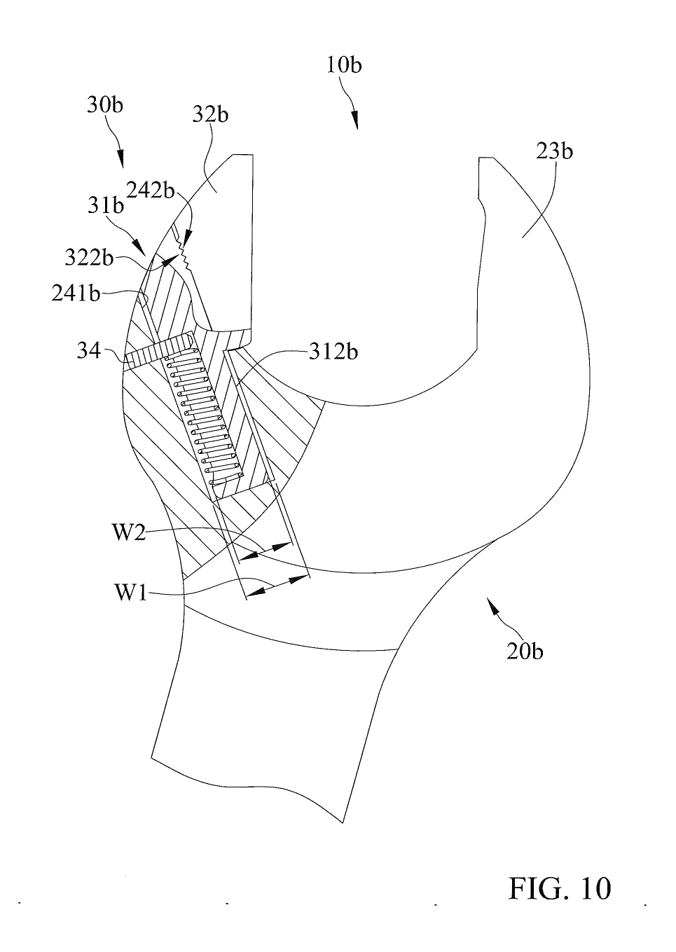

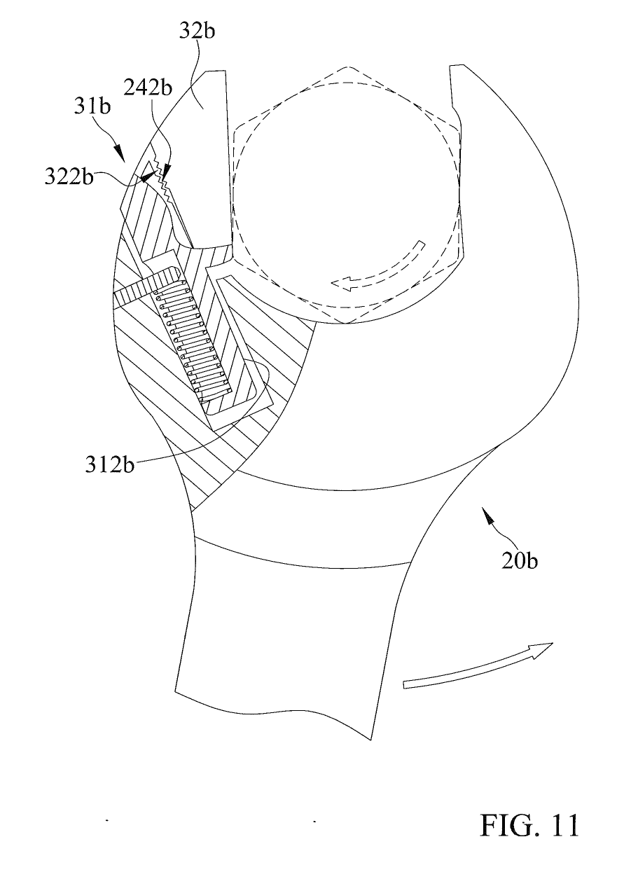

FIGS. 9 through 11 show a ratcheting wrench 10b in accordance with a third embodiment of the present invention. The ratcheting wrench 10b is similar to the ratcheting wrench 10a. A slot 241b is formed on an edge of the body 20b. However, the ratcheting wrench 10b differentiates from the ratcheting wrench 10a in that it includes a slider 31b and a pawl 32b as an integral and single structure. The slot 241b has a first width W1 in a width direction thereof, which is perpendicular to a length direction of the slot 241b. The slider 31b has a second width W2 in a width direction thereof. The second width W2 is smaller than 0.95 times of the first width W1. As such, a space is formed between the second side 312b of the pawl 32 and a lateral wall of the slot 241b, with the second side 312b of the pawl and the lateral wall of the slot 241b being substantially parallel to one another. Preferably, the second width W2 is between 0.8 and 0.9 times of the first width W1.

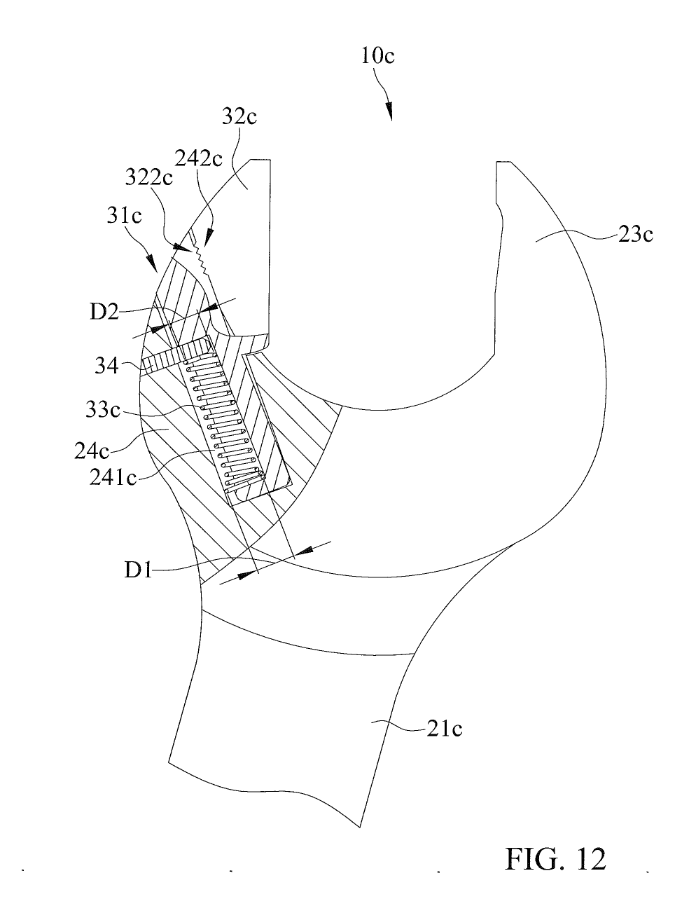

FIG. 12 shows a ratcheting wrench 10c in accordance with a fourth embodiment of the present invention. The ratcheting wrench 10c is similar to the ratcheting wrench 10b. The ratcheting wrench 10c includes a first body portion 21c. A slider 31c is movable and disposed on a second jaw 24c. A second jaw 24c has an edge thereof including a first restraining structure 242c. The slider 31c bears a pawl 32c. The pawl 32 has an edge thereof including a second restraining structure 322c. The second restraining structure 322c is serrated. The first and second restraining structures 242c and 322c have corresponding shapes. The slot 241c has a first width in a width direction thereof, which is perpendicular to a length direction of the slot 241c. The slider 31c has a second width in a width direction thereof. The second width is smaller than 0.95 times of the first width. However, the ratcheting wrench 10c differentiates from the ratcheting wrench 10b in that it includes a biasing member 33c disposed side by side with a slider 31c in the width direction of the slot 241c. The biasing member 33c has a first end with a first diameter D1 and a second end with a second diameter D2 respectively. The second diameter D2 is smaller than the first diameter D1. Consequently, the slider 31c is tilted, with a first end of the slider 31c toward a lateral wall of the slot by the first end of the biasing member 33c.

In view of the forgoing, each of the bodies 20, 20a, and 20b is configured to include the first jaw 23, 23b, and 23c and the second jaw 24, 24a, 24b, and 24c. Each of the second jaws 24, 24a, 24b, and 24c includes the first restraining structure 242, 242a, 242b, and 242c. Each of the ratchet mechanisms 30, and 30b connects to the second jaw 24 and 24b. The sliders 31, 31a, 31b, and 31c are movable and disposed on the second jaws 24, 24a, 24b, and 24c. The sliders 31, 31a, 31b, and 31c bear the pawls 32, 32a, 32b, and 32c. Each of the pawls 32, 32a, 32b, and 32c includes the second restraining structure 322, 322a, 322b, and 322c. The biasing members 33 and 33c connects to the slider 31 and 31c.

The pawls 32, 32a, 32b, and 32c are selectively changeable between the first position in which the second restraining structures 322, 322a, 322b, and 322c correspond to and engage with the first restraining structures 242, 242a, 242b, and 242c and the second position in which the second restraining structures 322, 322a, 322b, and 322c disengage from the first restraining structures 242, 242a, 242b, and 242c.

When the ratcheting wrenches 10, 10a, 10b, and 10c are used to turn the object 90, the pawls 32, 32a, 32b and 32c and the second jaws 24, 24a, 24b, and 24c can anti-slip relative to one another, with the first and second restraining structures 242, 242a, 242b, 242c, 322, 322a, 322b, and 322c engaging with one another. However, the pawl 32, 32a, 32b and 32c and the second jaw, 24, 24a, and 24c disengage from each another when the ratcheting wrenches 10, 10a, 10b, and 10c turn relative to the object 90.

While the specific embodiments have been illustrated and described, numerous modifications come to mind without significantly departing from the spirit of invention, and the scope of invention is only limited by the scope of the accompanying claims.

What is claimed is:

1. A ratcheting wrench comprising:
a body including a first body portion and a second body portion, with the second body portion extending from the first body portion, with the second body portion configured to include a first jaw and a second jaw, with the first and second jaws including a gap in between, and with the second jaw having an edge thereof including a first restraining structure; and
a ratchet mechanism connecting to the second jaw and including a slider, a pawl, and a biasing member, with the slider being movable and disposed on the second jaw, with the slider bearing the pawl, with the pawl including a second restraining structure, with the biasing member connecting to the slider;
wherein the pawl is selectively changeable between a first position in which the second restraining structure corresponds to and engages with the first restraining structure and a second position in which the second restraining structure disengages from the first restraining structure.

2. The ratcheting wrench as claimed in claim 1 further comprising a stopper disposed on the second jaw and retraining the slider on the second jaw.

3. The ratcheting wrench as claimed in claim 1, wherein the slider includes a side thereof including a channel, and wherein the biasing member is constrained in the channel.

4. The ratcheting wrench as claimed in claim 2, wherein the slider includes a side thereof including a channel, and wherein the biasing member is constrained in the channel.

5. The ratcheting wrench as claimed in claim 4, wherein the stopper protrudes into the channel, wherein the biasing member has a first end restrained by the stopper and a second end restrained by a wall of the channel.

6. The ratcheting wrench as claimed in claim 1, wherein the pawl pivotally engages with the slider.

7. The ratcheting wrench as claimed in claim 7, wherein the pawl pivotally engages with the slider.

8. The ratcheting wrench as claimed in claim 6, wherein the slider includes a recess and the pawl includes a projection pivotally engaging in the recess.

9. The ratcheting wrench as claimed in claim 1 further comprising an elastic member connecting the slider and the pawl, and wherein the elastic member is adapted to exert a force on the pawl in a direction making the second restraining structure toward the first restraining structure.

10. The ratcheting wrench as claimed in claim 1, wherein the second jaw includes the edge thereof including a slot and the slider is movable and engaging in the slot.

11. The ratcheting wrench as claimed in claim 8, wherein the second jaw includes the edge thereof including a slot and the slider is movable and engaging in-the slot.

12. The ratcheting wrench as claimed in claim 11 further comprising an elastic member connecting the slider and the pawl, and wherein the elastic member is adapted to exert a force on the pawl in a direction making the second restraining structure toward the first restraining structure, with the pawl including the projection between the second restraining structure and the elastic member.

13. The ratcheting wrench as claimed in claim 11, wherein the slot has first and second distal ends opposite one another in a length direction of the slot, and wherein the slot includes the first distal end thereof delimited by a wall of the second jaw and the second distal end thereof forming an opening.

14. The ratcheting wrench as claimed in claim 11, wherein the slot in a width direction thereof having a first width, wherein the slider in a width direction thereof having a second width smaller than 0.95 times of the first width.

15. The ratcheting wrench as claimed in claim 14, wherein the second width is between 0.8 and 0.9 times of the first width.

16. The ratcheting wrench as claimed in claim 14, wherein the biasing member has a first end with a first diameter and a second end with a second diameter respectively, with the second diameter smaller than the first diameter, wherein the slider and the biasing member are disposed side by side in the width direction of the slot, and wherein the slider is tilted, with a first end of the slider toward a lateral wall of the slot by the first end of the biasing member.

17. The ratcheting wrench as claimed in claim 14, wherein the slider and the pawl are an integral and single structure.

18. The ratcheting wrench as claimed in claim 16, wherein the slider and the pawl are an integral and single structure.

19. The ratcheting wrench as claimed in claim 1, wherein the first and second restraining structures are serrated and have corresponding shapes.

20. The ratcheting wrench as claimed in claim 19, wherein the first restraining structure includes plurality of teeth, with each of the plurality of teeth having a length extending in a width direction of the second jaw, and wherein the second restraining structure includes plurality of teeth, with each of the plurality of teeth having a length extending in a width direction of the second jaw.
